(19) United States
(12) Patent Application Publication
(10) Pub. No.: US 2012/0281578 A1
(43) Pub. Date: Nov. 8, 2012

(54) METHOD FOR TRANSCEIVING CHANNEL INFORMATION, AND TERMINAL AND BASE STATION USING SAME

(75) Inventors: Sungkwon Hong, Seoul (KR); Kibum Kwon, Ansan-si (KR); Kyoungmin Park, Goyang-si (KR); Sungjin Suh, Seoul (KR)

(73) Assignee: Pantech Co., Ltd., Seoul (KR)

(21) Appl. No.: 13/515,705

(22) PCT Filed: Dec. 7, 2010
(86) PCT No.: PCT/KR2010/008685

§ 371 Date: Jul. 24, 2012

(30) Foreign Application Priority Data
Dec. 15, 2009 (KR) 10-2009-0124441
Dec. 6, 2010 (KR) 10-2010-0123233

(51) Int. Cl. H04W 24/10; H04W 72/08; H04W 72/06; H04W 72/04

(52) U.S. Cl. 370/252; 370/329

(57) ABSTRACT

The present description relates to a wireless communication system and to a method for transceiving channel information through carrier aggregation, and a terminal and a base station using the method. The method described in the present description comprises: receiving channel information from a user terminal, and generating a sub-band group from one or more subbands contained in at least one or more component carriers; and receiving, from the user terminal, channel information for each of the sub-band groups through a control channel.

### CROSS-REFERENCE TO RELATED APPLICATIONS

This application is the National Stage Entry of International Application PCT/KR2010/008685, filed on Dec. 7, 2010, and claims priority from and the benefit of Korean Patent Application No. 10-2009-0124441, filed on Dec. 15, 2009, and Korean Patent Application No. 10-2010-0123233, filed on Dec. 6, 2010, all of which are incorporated herein by reference for all purposes as if fully set forth herein.

### BACKGROUND

1. Field

The present invention relates to a wireless communication system, and more particularly, to a method of transmitting and receiving channel information through carrier aggregation, and a user equipment (UE) and a base station (Bs) using the same.

2. Discussion of the Background

As a bandwidth that a wireless communication system including a user equipment (UE) and a base station (BS) is able to use has increased or a plurality of component carriers (CCs) has been utilized, channel information that needs to be reported by the UE to the BS through a uplink (UL) so as to enable the BS to recognize a channel status of a downlink (DL), has also increased.

Accordingly, there is a desire for a method of effectively transmitting channel information that needs to be reported by the UE to the BS through the UL.

### SUMMARY

An aspect of the present invention is to provide a method of transmitting and receiving channel information through carrier aggregation, and a user equipment (UE) and a base station (BS) using the same.

Another aspect of the present invention is to provide a method of transmitting and receiving channel information by forming a group with respect to subbands including at least one CC, and a UE and a BS using the same.

Another aspect of the present invention is to provide a method of requesting group updating and performing group updating with respect to at least one subband, and a UE and a BS using the same.

Another aspect of the present invention is to provide a method of transmitting and receiving channel information that secures a backward compatibility when channel information is transmitted through carrier aggregation, and a UE and a BS is using the same.

Another aspect of the present invention is to provide a method of effectively transmitting and receiving channel information by simplifying a control channel when channel information is transmitted through carrier aggregation.

In accordance with an aspect of the present invention, there is provided a method for a base station (BS) to receive channel information in a wireless communication system using at least one component carrier (CC), the method including: receiving channel information from a user equipment (UE), generating a subband group with respect to one or more subbands included in the at least one CC, based on the received channel information, transmitting information associated with the generated subband group to the UE, and receiving, from the UE through a control channel, group-based channel information of each subband corresponding to the subband group, and the subband group includes at least one subband having the same channel information, and the information associated with the subband group includes a total number of generated subband groups, subband group identification information to be used for identifying each subband group, and subband identification information to be used for identifying a subband included in each subband group.

In accordance with another aspect of the present invention, there is provided a method for a UE to transmit channel information in a wireless communication system that uses at least one CC, the method including: transmitting, to a BS, channel information associated with one or more subbands included in the at least one CC, receiving, from the BS, information associated with a subband group generated by grouping the one or more subbands included in the at least one CC, transmitting, to the BS through a control channel, group-based channel information of each subband by using the channel information associated with the one or more subbands as the group-based channel information of each subband corresponding to the subband group, and the subband group includes at least one subband having the same channel information, and the information associated with the subband group includes a total number of generated subband groups, subband group identification information to be used for identifying each subband group, and subband identification information used for identifying a subband included in each subband group.

In accordance with another aspect of the present invention, there is provided a wireless communication system, the system including: a subband grouping management unit to generate a subband group with respect to one or more subbands included in at least one CC, based on channel information received from a UE, and a transceiving unit to transmit subband grouping information associated with the subband group to the UE, and to receive group-based channel information of each subband corresponding to the subband group through a control channel, and the subband group includes at least one subband having the same channel information, and the information associated with the subband group includes a total number of generated subband groups, subband group identification information to be used for identifying each subband group, and subband identification information to be used for identifying a subband included in each subband group.

In accordance with another aspect of the present invention, there is provided a UE, the UE including: a receiving unit to receive, from a BS, subband grouping information associated with a subband group generated by grouping one or is more subbands included in at least one CC, a subband channel information measuring unit to measure channel information associated with the one or more subbands included in the at least one CC, a subband group channel information measuring unit to form, using the channel information associated with the one or more subbands, group-based channel information of each subband corresponding to the subband grouping information, and a transmitting unit to transmit the group-based channel information of each subband corresponding to the subband group to the BS through a control channel.

As described in the foregoing, embodiments of the present invention may provide a backward compatibility when channel information is transmitted through carrier aggregation.

According to embodiments of the present invention, channel information may be transmitted for each subband group through subband grouping when the channel information is transmitted through carrier aggregation and thus, a control channel may be simplified and an amount of resources required for transmission may be significantly reduced.

### BRIEF DESCRIPTION OF THE DRAWINGS

FIG. 1 is a block diagram illustrating a wireless communication system according to an embodiment of the present invention;

FIG. 2 is a diagram illustrating channel transmission architecture in a wireless communication system that uses multiple component carriers (CCs) according to an embodiment of the present invention;

FIG. 3 is a diagram illustrating subband grouping according to an is embodiment of the present invention;

FIG. 4 is a diagram illustrating an example of grouping subbands having the same level according to an embodiment of the present invention;

FIG. 5 is a flowchart illustrating a process where a base station (BS) receives channel information of grouped subbands according to an embodiment of the present invention;

FIG. 6 is a flowchart illustrating a process where a user equipment (UE) transmits channel information of grouped subbands according to an embodiment of the present invention;

FIG. 7 is a diagram illustrating a transmission architecture for subband group information according to an embodiment of the present invention;

FIG. 8 is a diagram illustrating a transmission architecture for a subband group updating request according to an embodiment of the present invention;

FIG. 9 is a diagram illustrating a configuration of a BS that transmits information associated with grouped subbands according to an embodiment of the present invention; and

FIG. 10 is a diagram illustrating a configuration of a UE that transmits channel information of grouped subbands according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the is same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

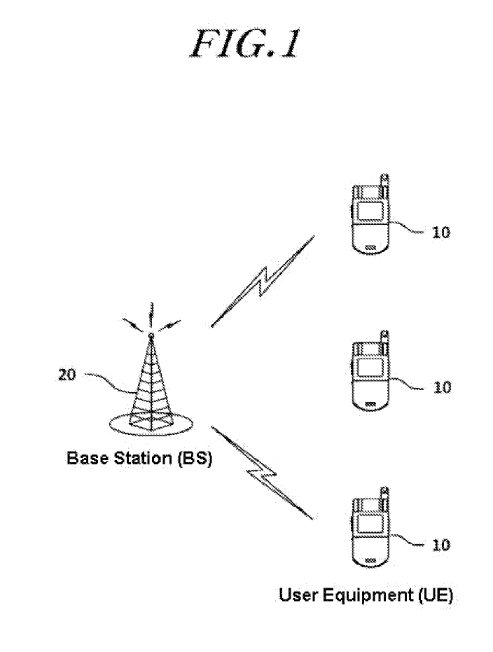

FIG. 1 illustrates a wireless communication system 100 to transmit channel information according to an embodiment of the present invention.

FIG. 1 is a block diagram illustrating a wireless communication system according to an embodiment of the present invention. The wireless communication system is a system to provide various communication services such as voice data, packet data, and the like.

Referring to FIG. 1, the wireless communication system may include a user equipment (UE) 10 and a base station (BS) 20.

Throughout the specifications, the UE 10 may be an inclusive concept is indicating a user terminal utilized in wireless communication, including a UE in WCDMA, LTE, HSPA, and the like, and a mobile station (MS), a user terminal (UT), a subscriber station (SS), a wireless device, and the like in GSM.

In general, the BE 20 or a cell may refer to a fixed station where communication with the UE 10 is performed, and may also be referred to as a Node-B, an evolved Node-B (eNB), a base transceiver system (BTS), an access point, and the like.

The BS 20 or the cell may be construed as an inclusive concept indicating a portion of an area covered by a base station (BS) in CDMA, a Node-B in WCDMA, and the like, and the concept may include various coverage areas, such as a megacell, macrocell, a microcell, a picocell, a femtocell, and the like.

The UE 10 and the BS 20 may be used as two inclusive transceiving subjects to embody the technology and technical concepts described in the specifications, and may not be limited to a predetermined term or word. Here, an uplink (UL) refers to a scheme of transmitting and receiving data from the UE 10 to the BS 20, and a downlink (DL) refers to a scheme of transmitting and receiving data from the BS 20 to the UE 10.

Hereinafter, a multiple access scheme applied to the wireless communication system is not limited. The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

UL transmission and DL transmission may be performed based on a time division duplex (TDD) scheme that performs transmission based on different times, or is based on a frequency division duplex (FDD) scheme that performs transmission based on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

Hereinafter, a channel information transmitting method of reducing an amount of channel information increased due to use of at least one component carrier (CC) will be described.

In the wireless communication system that provides the channel information transmitting method, at least one CC may be used, the UE 10 measures channel information for each subband associated with each CC, and the UE 10 may transmit, to the BS 20, subband group-based channel information that is generated based on the channel information measured for each subband.

That is, the channel information may be transmitted for each subband group (subband group-based channel information), as opposed to being transmitted for each subband (subband-based channel information) and thus, an amount of UL resources required for reporting by the UE 10 to the BS 20 through a UL may be significantly reduced.

Referring to FIG. 1, in the wireless communication system that uses one or more CCs, each UE 10 may measure subband-based channel information associated with each CC. Also, the UE 10 may transmit, to the BS through a control channel, subband group-based channel information for each subband group generated by grouping one or more subbands associated with one or more CCs, based on the measured channel information for each subband. That is, embodiments of the present invention will describe a configuration and a process of transmitting subband group-based channel information by grouping a plurality of subbands included in a single CC, or by grouping a plurality of subbands included in one or more CCs.

In embodiments of the present invention, the control channel may be, for example, a physical uplink control channel (PUCCH) in 3GPP LTE/LTE-A.

The channel information measured for each subband described in the forgoing may include, for example, at least one of a channel quality indicator (CQI), precoding matrix indicators (PMI), a rank indicator (RI), a signal-to-noise ratio (SNR), a frame error rate (FER), and the like. Embodiments of the present invention may not be limited to the examples of the channel information, and, as the embodiments of the present invention are embodied, the channel information may include various information used for measuring various characteristics and qualities of a channel or for providing measured results, for example, information indicating a degree of noise of a channel, information associated with an error occurring in a channel, channel status information, information associated with measured quality of a channel, indication information thereof (indicator), and the like.

In the wireless communication system that uses one or more CCs, the BS 20 may receive, from the UE 10, subband-based channel information associated with each CC, may generate a subband group by grouping subbands based on the subband-based channel information associated with each CC, may transmit subband grouping information to the UE 10, and may receive subband group-based channel information from the UE 10.

Here, “subband grouping” performed by the BS 20 based on “subband-based channel information associated with each CC” received from the UE 10 may correspond to inter-carrier subband grouping that performs subband grouping by connecting subbands in different CCs, intra-carrier subband grouping that performs subband grouping by connecting subbands in the same CC, or subband grouping that performs subband grouping based on both the inter-carrier subband grouping and the intra-carrier subband grouping.

That is, embodiments of the present invention may group a plurality of subbands into a single subband group, and the plurality of subbands may be included in i) a single CC (intra-carrier), may be included in ii) multiple CCs (inter-carrier), or may be grouped based on iii) the combination of the two schemes (intra-carrier and inter-carrier). In a case of ii) or a case of iii), channel information of multiple carriers may be transmitted.

The “subband grouping information” obtained by the subband grouping as described in the foregoing may include, for example, at least one of a total number of generated subband groups, subband group identification information to be used for identifying each subband group, subband identification information to be used for identifying a subband included in each subband group, and the like.

The UE 10 may extract a parameter to be used for updating a subband group, based on subband-based channel information and subband group-based channel information associated with each CC, may generate subband group updating request information when the parameter exceeds a tolerance, and may transmit the subband group updating request information to the BS 20. According to an embodiment of the present invention, the parameter may be computed based on a difference between the subband group-based channel information and the subband-based channel information of a corresponding group.

The “subband group updating request information” transmitted by the UE 10 to the BS 20 may include at least one of information associated with a validity of entire subband grouping, information associated with a list of subband groups that exceed a tolerance, and information associated with an excess over a tolerance for each subband group included in the list of the subband groups.

When the BS 20 receives the subband group updating request information from the UE 10, the BS 20 may determine whether to perform partial subband grouping or global subband grouping based on the received subband group updating request information, and may perform either the partial subband grouping or the global subband grouping.

To achieve the above described channel information transmission, the UE 10 may include a subband-based channel information measuring unit to measure subband-based channel information associated with each CC, a subband group-based channel information calculator to receive subband grouping information from the BS 20 based on the measured subband-based channel information associated with each CC, to calculate subband group-based channel information based on the subband grouping information, and to transmit the subband group-based channel information to the BS 20, a subband group updating management unit to extract a parameter to be used for updating a subband group, based on the subband-based channel information associated with each measured CC and the calculated subband group-based channel information, to determine whether the extracted parameter is less than or equal to a tolerance, and to generate subband group updating request information when the extracted parameter is greater than the tolerance so as to transmit the subband group updating request information to the BS 20, and the like.

To achieve the above described channel information transmission, the BS 20 may include a subband grouping management unit to classify subbands based on subband-based channel information associated with each CC, received from the UE 10, to generate a subband group by grouping the subbands based on a result of the classification, and to transmit, to the UE 10, subband grouping information associated with the subband grouping, a subband group-based channel information receiving unit to receive subband-group based channel information associated with the subband grouping information from the UE 10, and the like.

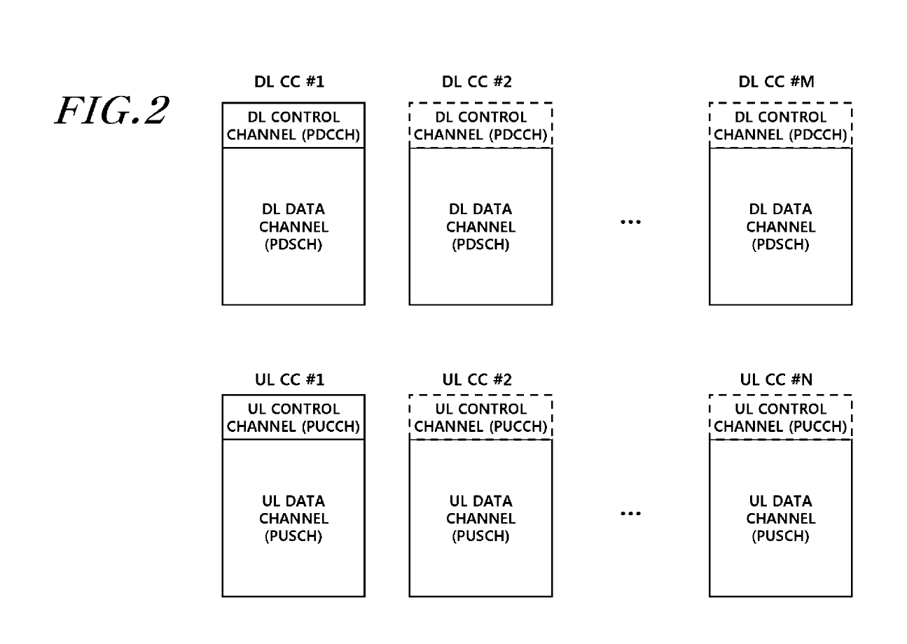

The wireless communication system including the UE 10 and the BS 20 may be applied to LTE-A which defines multiple-carriers aggregation. Hereinafter, a channel information transmitting method according to another embodiment of the present invention applied to LTE-A will be described with reference to FIGS. 2 through 8.

In LTE, a standard may be developed by forming a UL and a DL based on a single CC or a pair of CCs. The UL and the DL may transmit control information through a control channel, such as a physical downlink control channel (PDCCH), a physical control format indicator channel (PCFICH), a physical hybrid ARQ indicator channel (PHICH), a physical uplink control channel (PUCCH), and the like, and may be configured as a data channel, such as a physical downlink shared channel (PDSCH), a physical uplink shared channel (PUSCH), and the like, so as to transmit data.

The data channel may be configured based on a resource block (RB), and the RB may be configured in two dimensions of a time and a frequency. Control information associated with allocation of resources for each user and for each service may be transmitted and managed by a control channel that is determined by an upper layer of a physical layer of a service eNB

LTE-A uses a standard based on a single CC as a base (unit) and has discussed coupling of a few bands having a bandwidth of 20 megahertz (MHz) or less, whereas LTE-A has discussed a band of a CC having a bandwidth of 20 megahertz (MHz) or more.

LTE-A has discussed a multiple-carrier aggregation by taking backward compatibility into consideration based on the base standard of LTE. In a UL and a DL, five or more CCs are taken into consideration. The important issue in the discussion of the carrier aggregation may be how to extend a control channel and how to form a data channel, as a number of CCs increases.

In the UL and the DL, one or more CCs or a pair of CCs may be referred to as an anchor carrier, a primary cell, a serving cell, or a special cell, and there may exist a CC that may access the UE 10 in an initial stage and may receive security and authentication information, and may be controlled with respect to a multiple-carrier aggregation.

With respect to the carrier aggregation, UL acknowledgement/negative acknowledgement (ACK/NACK) transmission and DL channel information transmission including a CQI, a PMI, and an RI are to be taken into consideration among various pieces of information associated with designing of a control channel. The CQI/PMI/RI information may be transmitted based on various schemes through a PUCCH and a PUSCH which are UL control channels.

In a case of the CQI, as an example of channel status information transmitted through the UL, CQI information may be transmitted by periodic CQI reporting or aperiodic CQI reporting. In the aperiodic CQI reporting, the CQI may be transmitted through a PUSCH to which a UL resource is allocated by the BS 20, and the CQI information may be reported by distinguishing a feedback associated with a total band, a feedback associated with a subband formed by the BS 20, and a feedback associated with a subband set by the UE 10. A size of a subband may be determined based on a size of a system band of an LTE system. When the periodic CQI reporting is performed through a PUCCH, feedback reporting associated with a subband formed by the BS 20 from among the three feedback schemes of the PUSCH may not be supported.

For example, transmission of the CQI information through the PUCCH may be used for transmitting information of 4 through 13 bits in a 2/2a/2b form, and the CQI may be reported in an appropriate form based on whether an MIMO scheme is used, a degree of a rank, a length of a CP of a system, and the like.

Embodiments of the present invention may not be limited to the examples of the channel information or the channel status information, and, as the embodiments of the present invention are embodied, the channel information may include various channel status information, for example, various information used for measuring characteristics and quality of a channel or providing measured results.

In a channel information transmitting method according to an embodiment of the present invention, it is assumed that M DL CCs exist with respect to a DL and N UL CCs exist with respect to a UL. A CC may refer to a CC included in a plurality of CCs used by the wireless communication system.

Referring to FIG. 2, each DL CC may include a data channel such as a PDSCH. However, each DL CC may or may not include a control channel such as a PDCCH. That is, all the DL CCs may include control channels, or a few of the DL CCs may include control channels such as a PDCCH.

Each UL CC may include a data channel such as a PUSCH. Each UL CC may or may not include a control channel. That is, all the UL CCs may include control channels, or a few of the DL CCs may include control channels such as a PUCCH.

That is, a few of all the DL CCs may selectively include control channels such as a PDCCH. Also, a few of the UL CCs may selectively select control channels such as a PUCCH.

In the channel information transmitting method according to an embodiment of the present invention, a “subband group” may be formed by connecting subbands based on an intra-carrier scheme and an inter-carrier scheme. Here, a subband (SB) is a unit for UL reporting.

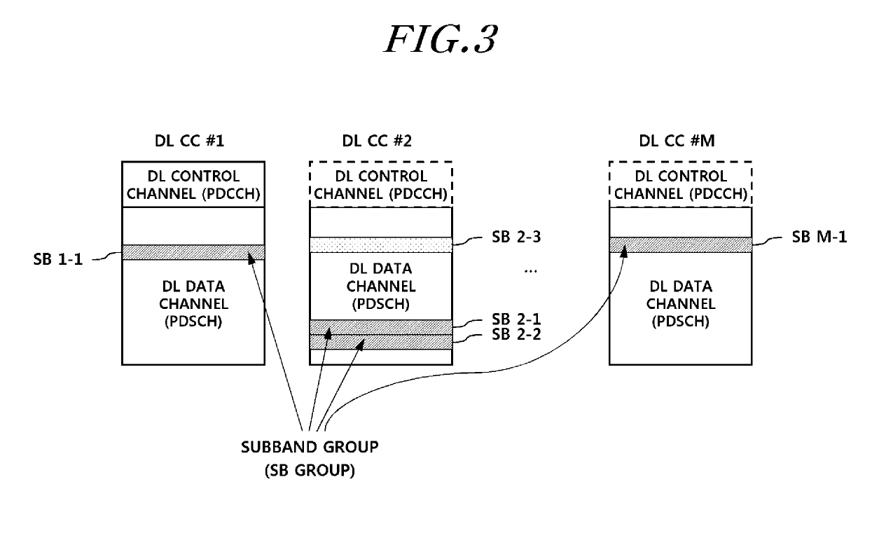

FIG. 3 illustrates subband grouping according to an embodiment of the present invention.

Referring to FIG. 3, a subband 1-1 (SB 1-1) in a DL CC #1, a subband 2-1 (SB 2-1) and a subband 2-2 (SB 2-2) in a DL CC #2, and a subband M-1 (SB M-1) in a DL #M may form the same subband group. Also, a subband 2-3 (SB 2-3) in the DL CC #2 may be a subband that is not grouped with another DL CC.

A subband group defined in an embodiment of the present invention may generally include a definition of a subband that is a unit of channel information transmitted in a UL, such as CQI/PMI/RI information, defined in LTE/LTE-A.

Embodiments of the present invention may not be limited to the examples of the channel information, and, as the embodiments of the present invention are embodied, the channel information may include various information used for measuring characteristics and qualities of a channel or for providing measured results. That is, a subband group may refer to an object that may be represented by or reported as a predetermined channel information value.

A subband that is not grouped within a CC may exist, and the subband may be regarded as a subband group of which a number of subbands included in the group is one. A number of subbands of each CC of carrier aggregation may be the same for each carrier aggregation or may be different from one another. It is because a characteristic of a channel of each CC may be changed for each UE 10, and subband grouping may not need to uniformly collect subbands for each CC. Also, a single CC of to a subband group may be defined to be a subband.

A rule of subband grouping that groups subbands into a group may be as follows.

Subbands may be distinguished based on subbands that have reported in an UL for each CC or for each intra-CC. Subbands may be distinguished as a subband of which a channel status is in a semi-static status and a subband of which a channel status is relatively rapidly changed over time. Also, in each case, channels may be distinguished as a channel having a relatively high SNR and a channel having a relatively low SNR. Subband grouping may be performed with respect to subbands having stable and similar SNR levels, and may be performed with respect to subbands having unstable and similar SNR levels.

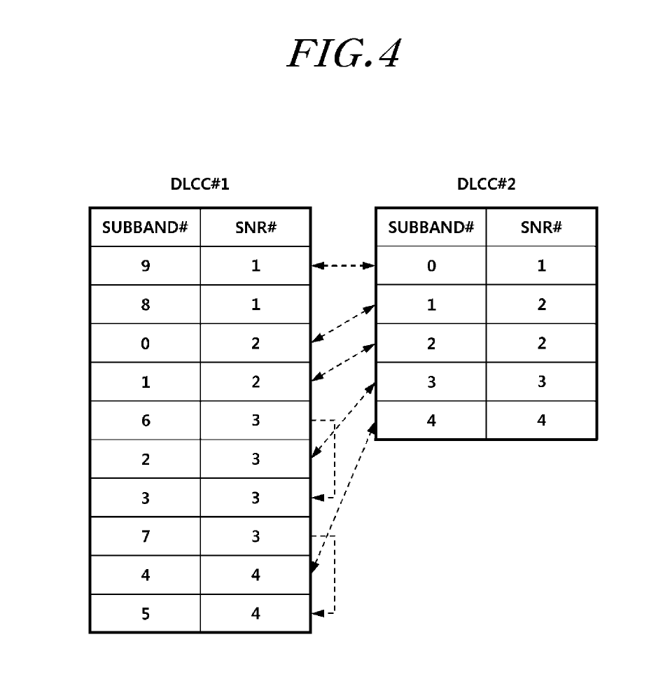

FIG. 4 illustrates an example of grouping subbands having the same level according to an embodiment of the present invention.

Referring to FIG. 4, two CCs represented by a DL CC #1 and a DL CC #2 are used. The DL CC #1 may include ten subbands represented by 0 through 9, and the DL CC #2 may include five subbands represented by 0 through 4.

The BS 20 may receive subband-based channel information, for example, an SNR level, of the DL CC #1 and the DL CC #2 fed back or reported by the UE 10, and may group subbands having the same SNR level into a subband group as illustrated in FIG. 4.

For example, the subband 9 of the DL CC #1 and the subband 0 of the DL CC #2 have the same SNR level of “1” and thus, the subband 9 and the subband 0, which are subbands of different CCs, may be grouped into the same subband group.

As another example, the subband 3 and the subband 6 of the CC #1 may have the same SNR level of “3” and thus, the subband 3 and the subband 6, which are subbands of the same CC, may be grouped into the same subband group. Although not illustrated in FIG. 4, the subband 3 and the subband 6 of the CC #1, and the subband 3 of the DL CC #2 have the same SNR level of “3” and thus, subbands of the same CC in is combination with a subband of different CC may be grouped into a single subband group.

In this example, a subband that is not included in a subband group, such as a subband 8 of the CC #1, may exist.

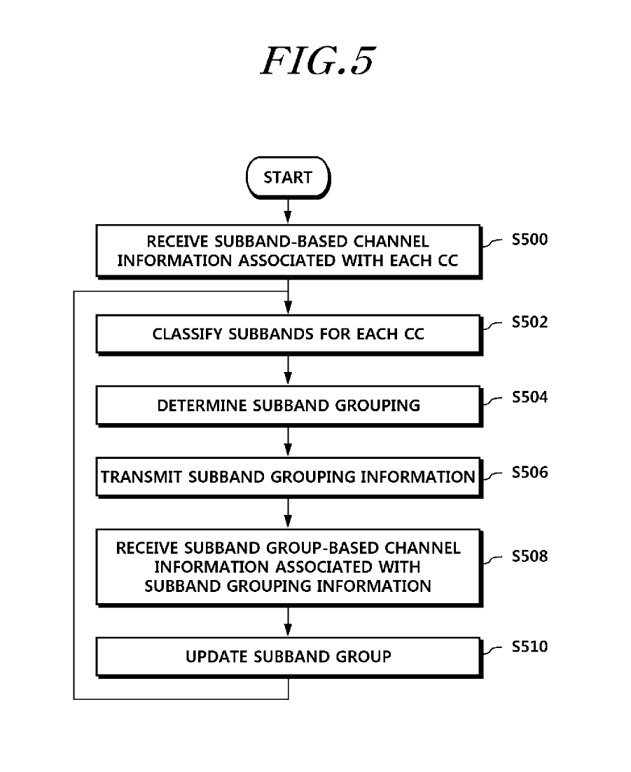

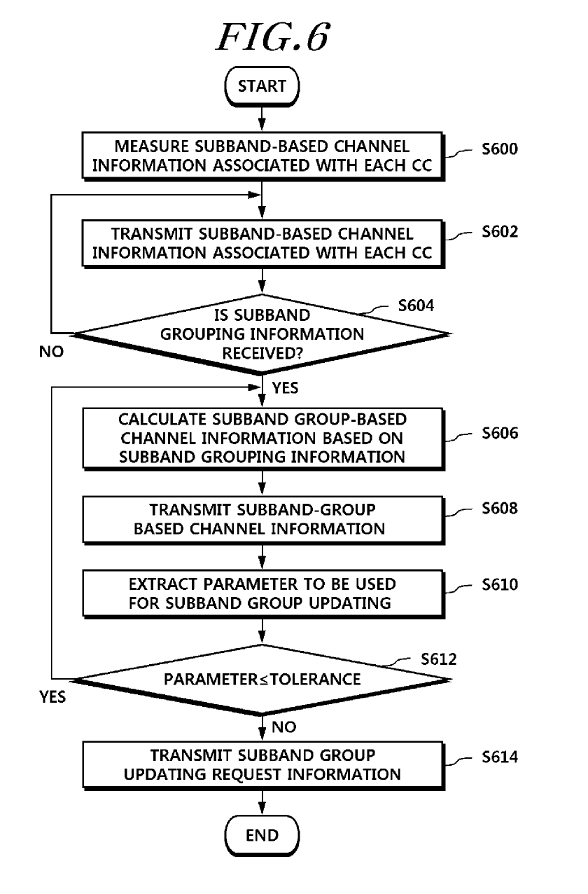

Hereinafter, operations of the BS 20 and the UE 10 for transmission of channel information according to another embodiment of the present invention will be described with reference to FIGS. 5 and 6.

FIG. 5 illustrates a process where a BS receives channel information of grouped subbands according to an embodiment of the present invention.

Referring to FIG. 5, in an initial operation, the BS 20 may receive, from the UE 10, subband-based channel information associated with each CC measured by the UE 10 (step S500).

Subsequently, the BS 20 may classify subbands for each CC, based on the received subband-based channel information associated with each CC (step S502).

Based on a result of the classification, subband grouping may be determined (step S5404). The determined subband group may be included in i) a single CC (intra-carrier), may be included in ii) multiple CCs (inter-carrier), or may be based on iii) the combination of the two schemes (intra-carrier and inter-carrier).

The subband grouping may determine, for each UE 10, a subband group that may reduce a load of transmission of UL control information and may have low deterioration in a DL capacity. This may not need to be performed for the entire band of the UE 10 and may need to be performed for a predetermined band. The configuration of a subband group may be transferred to the UE 10 in a DL in a form of subband grouping information (referred to as “control information A”). The subband grouping information, is also referred to as control information A, may be configured as information associated with a subband group formed by grouping subbands having similar characteristics for each CC or information associated with a subband group formed by grouping at least one subband having a similar characteristic included in at least one CC.

The subband grouping information associated with the determined subband grouping may be transmitted to the UE 10 (step S506). After the subband grouping information is transmitted to the UE 10, the subband group-based channel information associated with the subband grouping information may be received from the UE (step S508). In this example, for a subband that does not form a subband group, subband-based channel information may be received from the UE 10 in the same manner as before.

When subband group updating request information is received from the UE 10, whether to perform subband group updating may be determined and partial or global subband group updating may be performed by performing the steps from step 502.

In particular, the BS 20 may determine a subband group that has a difference in channel information, for example, CQI/PMI/RI information and the like, based on the subband group updating request information, and may determine whether to partially update subband grouping or to globally update subband grouping to be the same as an initialization status, based on the subband group updating request information. Therefore, the subband grouping information may be updated, and the subband grouping information in a form of the control A may be reported to the UE 10.

Embodiments of the present invention may not be limited to the examples of the channel information and the channel status information, and, as the embodiments of the present invention are embodied, the channel information may include various channel status information such as various information used for measuring characteristics and qualities or for providing measured results. That is, a subband group may refer to an object that may be represented by or reported as a predetermined channel information value. According to an embodiment of the present invention, a BS may be configured to perform the process of FIG. 5.

FIG. 6 illustrates a process where a UE transmits channel information of grouped subbands according to an embodiment of the present invention.

Referring to FIG. 6, in an initial status before performing subband grouping, the UE 10 may measure subband-based channel information associated with each CC, for example, CQI/PMI/RI information (step S600). Subsequently, the UE 10 may transmit, to the BS 20, the measured subband-based channel information associated with each CC (S602). From the initial status, subband grouping may start based on a predetermined rule, previous access records of the UE 10, information received from another BS, information collected from another UE 10, information associated with an initial ramping process of the UE 10, and the like. In this example, an operation of the BS 20 with respect to the UE 10 may be performed from a subband determining block.

Subsequently, the UE 10 may determine whether subband grouping information is received from the BS 20 (step S604), may calculate subband group-based channel information based on the received subband grouping information (step S606) when the subband grouping information is received, and may transmit the calculated subband group-based channel information to the BS 20 (step S608). The received subband group may be included in i) a single CC (intra-carrier), may be included in ii) multiple CCs (inter-carrier), or may be grouped based on iii) the combination of the two schemes (intra-carrier and inter-carrier).

The UE 10 may transmit subband group-based channel information based on a newly formed subband group through use of the subband grouping information, instead of transmitting the initial subband-based channel information associated with each CC, for example, CQI/PMI/RI information. Embodiments of the present invention may not be limited to the examples of the channel information, and, as the embodiment of the present invention are embodied, the channel information may include various channel status information, for example, various information used for measuring characteristics and qualities or for providing measured results. That is, a subband group may refer to an object that may be represented by or reported as a predetermined channel information value.

The UE 10 may compare the subband group-based channel information calculated in step S606 with the subband-based channel information associated with each CC measured in step S600, and may extract a parameter to be used for updating a subband group (step S610). Here, the extracted parameter may be one of the subband-based channel information associated with each CC measured in step S600.

For example, although the subband group-based channel information, for example, CQI/PMI/RI information, is transmitted, the subband-based channel information, for example, CQI/PMI/RI information, may be measured for each CC with respect to a formed subband group. A difference between the two pieces of information may be checked by comparing the measured subband-based channel information and the subband group-based channel information (CQI/PMI/RI information), and whether to perform subband group updating may be determined based on a result of the checking and the BS 20 may be informed about the determination.

The UE 10 may compare the extracted parameter and a tolerance (step S612), may determine that a previously generated subband group does not match a current channel status when the parameter exceeds the tolerance, and may transmit group updating request information to the BS 20 (step S614).

For example, when the difference between the two pieces of information exceeds a predetermined threshold, that is, the tolerance, this may be reported to the BS 20 through use of subband group updating request information (referred to as control information B). The subband group updating request information may also be determined based on an FER value that is calculated based on ACK/NACK information that may be detected from a DL data channel associated with a subband group, in addition to CQI/PMI/RI. In addition, the channel information may also include various channel status information, for example, various information used for measuring characteristics and qualities or for providing measured results. That is, a subband group may refer to an object that may be represented by or reported as a predetermined channel information value.

The subband group updating request information may be configured as information merely indicating a validity of a subband group or information indicating a subband of a subband group that has a difference in channel information, for example, a CQI/PMI/RI and the like, and a degree of the difference.

However, when the parameter is less than or equal to the tolerance, the UE 10 may determine that the previously generated subband group matches the current is channel status, may continuously perform steps from step S606 so as to transmit subband group-based channel information to a BS. According to an embodiment of the present invention, a UE may be configured to perform the process of FIG. 6.

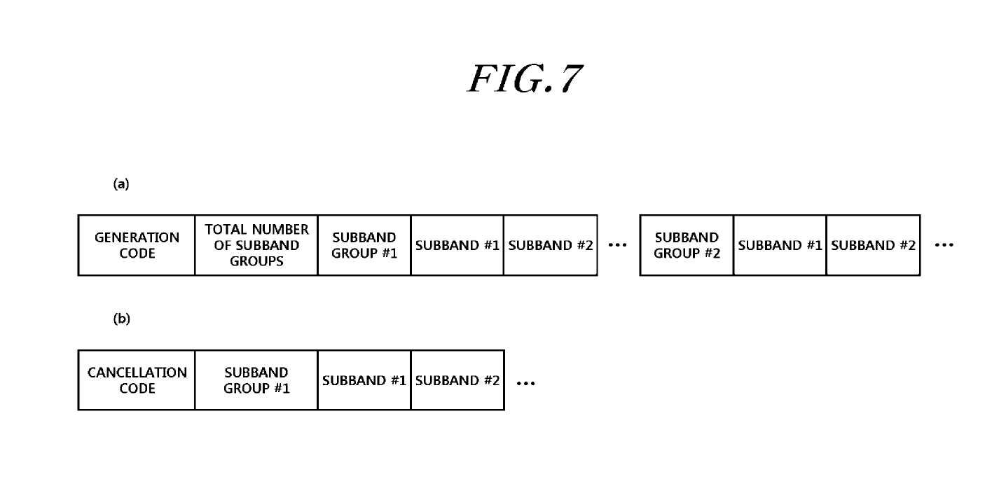

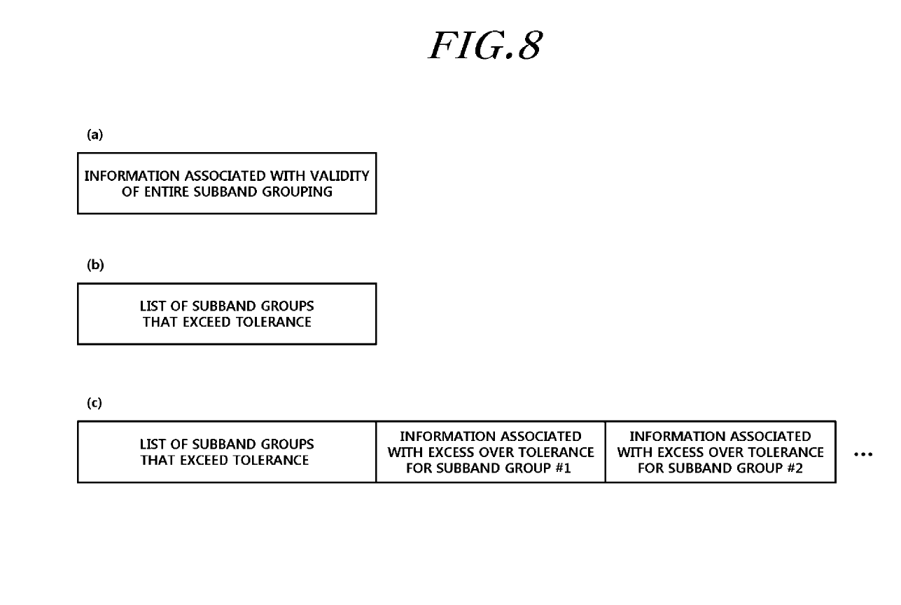

The subband grouping information in the form of the control A and the subband group updating request information in the form of the control B may be configured, for example, as illustrated in FIGS. 7 and 8. FIG. 7 illustrates a transmission architecture for subband group information according to an embodiment of the present invention.

Referring to FIG. 7, subband grouping information in a form of control information A may be configured to be (a) or (b) of FIG. 7, based on whether the subband group is newly generated or cancelled.

Referring to (a) of FIG. 7, the subband grouping information corresponding to a case where a subband group is newly generated, may be configured to include a portion corresponding to a generation code indicating that a subband group is newly generated, a portion indicating a total number of newly generated subband groups, and a portion indicating identification information (number) to be used for identifying each subband group and a subband included in each subband group.

Referring to (b) of FIG. 7, the subband grouping information corresponding to a case where a subband group is cancelled, may be configured to include a portion corresponding to a cancellation code indicating that a subband group is cancelled and a portion indicating identification information (number) to be used for identifying a cancelled subband group and a subband included in the cancelled subband group.

FIG. 8 illustrates a transmission architecture for a subband group updating request according to an embodiment of the present invention.

As illustrated in FIG. 8, subband group updating request information in a form of control information B may be configured in one of the types including a type (a) of FIG. 8 indicating a validity of global subband grouping, a type (b) of FIG. 8 indicating a list of subband groups that have a problem in that a parameter used for updating a subband group exceeds a tolerance, and a type (c) of FIG. 8 indicating an excess of the parameter over a tolerance along with the list of the subband groups having the problem.

The subband grouping information in the form of control information A and the subband group updating request information in the form of control information B may be control information that does not exist in the existing LTE standards and thus, there is a desire for a new control channel to transfer the control information. The control channel may need to be determined based on upper layer signaling in an application where a subchannel group updating is performed slowly, whereas a new channel, defined in a corresponding physical layer, may need to be formed in an application where updating is relatively promptly performed.

Referring again to FIGS. 5 and 6, operations of the BS 20 and the UE 10 that transmit channel information including CQI/PMI/RI information and the like, to reported through an UL and a DL, through subband grouping will be described as follows.

In an initial stage before performing subband grouping, the UE 10 may transmit, to the BS 20, subband-based channel information, for example, CQI/PMI/RI information (step S602).

The BS 20 may receive, from the UE 10, channel information associated with each CC, for example, CQI/PMI/RI information, for each subband, and may classify a channel characteristic of each subband so as to perform subband grouping (steps S500, S502, and S504). The BS 20 may transfer, to the UE 10, information associated with configuration of a subband group in a form of subband grouping information (referred to as “control information A”), and the UE 10 may receive the subband grouping information including the configuration of the subband group (steps S506 and S604).

The UE 10 may transmit subband group-based channel information based on the newly formed subband group based on the subband grouping information, instead of transmitting subband-based channel information associated with each CC, for example, CQI/PMI/RI information (step S608).

Although the subband group-based channel information, for example, CQI/PMI/RI information, is transmitted for each subband group, subband-based channel information associated with each CC, for example, CQI/PMI/RI information, may be measured with respect to a formed subband group. A difference between the two pieces of information may be checked by comparing the measured subband-based channel information and the subband group-based channel information (CQI/PMI/RI information), and whether to perform subband group updating may be determined based on a result of the checking and the BS 20 may be informed about the determination (steps S610, S612, and S614). For example, when the difference between the two pieces of information exceeds a predetermined threshold, that is, a tolerance in step S612, subband group updating request information (referred to as control information B) may be transmitted to the BS 20 in step S614.

The BS 20 may determine a subband group that has a difference in channel information, for example, CQI/PMI/RI information and the like, based on the subband group updating request information, and may determine whether to partially update subchannel grouping or globally update subchannel grouping to be the same as an initialization status, based on the subband group updating request information. Accordingly, the subband grouping information may be updated, and the UE 10 may be informed about the subband grouping information in the form of the control information A (step S510).

The configurations of the BS 20 and the UE 10 to transmit channel information, reported in a UL and a DL, through subband grouping will be described as follows.

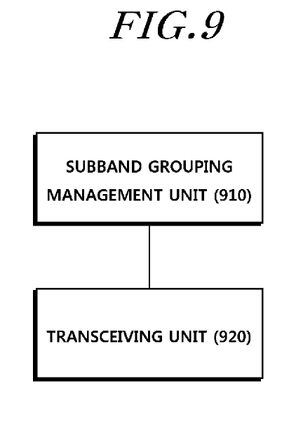

FIG. 9 illustrates a configuration of a BS that transmits information associated with grouped subbands according to an embodiment of the present invention.

Referring to FIG. 9, the BS may include a module to manage subband grouping (subband grouping management unit 910), and a transceiving unit 920 to perform transmission and reception of information with a UE.

In particular, the subband grouping management unit 910 may generate a subband group including subbands based on channel information associated with the subbands, received from the UE. The transceiving unit 920 may receive the channel information associated with the subbands from the UE, may transmit, to the UE, subband grouping information associated with the subband group, and may receive channel information associated with the subband group from the UE.

Here, a subband may be included in one or more CCs. A subband group may include at least one subband having the same channel information. Information associated with the subband group may include at least one of a total number of generated subband groups, subband group identification information to be used for identifying each subband group, and subband identification information to be used for identifying a subband included in each subband group.

When the UE transmits subband group updating request information separately and the transceiving unit 920 receives the subband group updating request information, the subband grouping management unit 910 may generate information associated with an updated subband group, and the transceiving unit 920 may transmit the information to the UE.

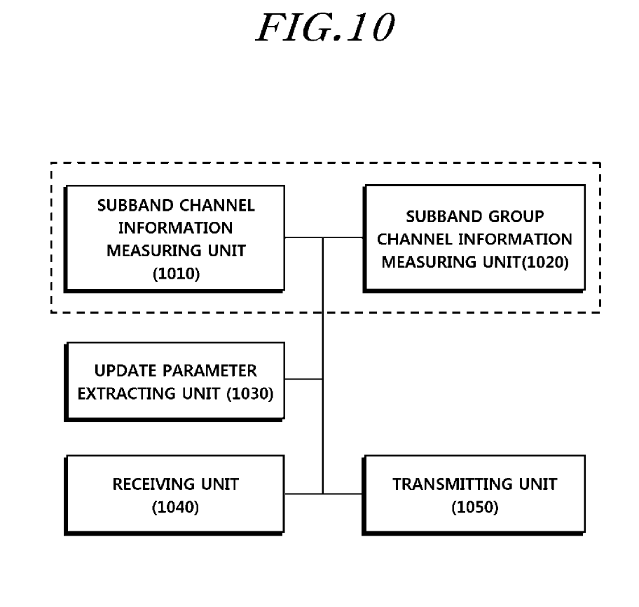

FIG. 10 illustrates a configuration of a UE that transmits channel information of grouped subbands according to an embodiment.

Referring to FIG. 10, the UE may include a receiving unit 1040 to receive subband grouping information associated with a subband group generated by grouping one or more subbands included in at least one CC, a subband channel information measuring unit 1010 to measure channel information associated with the one or more subbands included in the at least one CC, a subband group channel information measuring unit 1020 to form group-based channel information of each subband corresponding to the subband grouping information through use of the channel information associated with the one or more subbands, and a transmitting unit 1050 to transmit, to a BS through a control channel, the group-based channel information of each subband corresponding to the subband group.

Here, the subband group channel information measuring unit 1020 that measures subband group-based channel information may be configured as the same unit as the subband channel information measuring unit 1010. In this example, the subband group channel information measuring unit 1020 that provides a function of the subband channel information measuring unit 1010 may measure channel information associated with the one or more subbands included in the at least one CC, and may form group-based channel information of each subband corresponding to the subband grouping information. Also, the subband group channel information measuring unit 1020 may receive channel information associated with subbands measured by the subband channel information measuring unit 1010, and may form the subband group-based channel information.

In this example, the UE may further include an update parameter extracting unit 130. The update parameter extracting unit 130 may extract a parameter to be used for updating a subband group, based on the channel information measured by the subband channel information measuring unit 1010 and the subband group-based channel information measured by the subband group channel information measuring unit 1020, and the transmitting unit may generate subband group updating request information when the parameter exceeds a predetermined tolerance so as to transmit the subband group updating request information to the BS.

In FIGS. 9 and 10, the subband grouping information (“control information A” as described in FIG. 7) including configuration of the subband group may be configured as information associated with a subband group formed by grouping subbands having similar characteristics for each CC, or as information associated with a subband group formed by grouping at least one subband having a similar characteristic included in at least one CC.

In a case where a subband group is generated as shown in (a) of FIG. 7, the information associated with the subband group may include at least one of a generation code indicating generation of a subband group, a total number of generated subband groups, subband group identification information to be use for identifying each subband group, and a subband identification information (number) to be used for identifying a subband included in each subband group.

In a case where a subband group is cancelled as shown in (b) of FIG. 7, the information associated with the subband group may include at least one of a cancellation code indicating cancellation of a subband group and a portion indicating identification information (number) associated with a cancelled subband group and a subband included in the cancelled subband group

In FIGS. 9 and 10, the subband group updating request information (“control information B” as described in FIG. 8) may be determined based on an FER value calculated based on ACK/NACK information that may be detected from a DL data channel associated with a subband group, in addition to CQI/PMI/RI. In addition, the channel information may include various channel status information, for example, information for measuring characteristics and qualities or for providing a measured results.

That is, according to the embodiments of the present invention, a subband group may refer to an object that may be represented by or reported as a predetermined channel information value. The subband group updating request information may be embodied in a way that indicates a validity of subband grouping as shown in (a) of FIG. 8, that indicates a list of subband groups having a problem in that a parameter to be used for subband group updating exceeds a tolerance as shown in (b) of FIG. 8, or that transfers an excess of the parameter over the tolerance along with the list of the subband group having the problem, as shown in (c) of FIG. 8.

The subband group of FIGS. 9 and 10 may include i) subbands of a single CC (intra-carrier), may include ii) subbands included in multiple CCs (inter-carrier), or may be formed based on iii) the combination of the two schemes (intra-carrier and inter-carrier).

The control channel of FIGS. 9 and 10 may be, for example, a PUCCH, and channel information may include at least one of CQI information, a PMI, an RI, information indicating a degree of noise of channel, information associated with an error occurring in a channel, channel status information, and information associated with a measured quality of a channel.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method for a base station (BS) to receive channel information in a wireless communication system using at least one component carrier (CC), the method comprising:
receiving channel information from a user equipment (UE);
generating a subband group with respect to one or more subbands included in the at least one CC, based on the received channel information;
transmitting information associated with the generated subband group to the UE; and
receiving, from the UE through a control channel, group-based channel information of each subband corresponding to the subband group,
wherein the subband group comprises at least one subband having the same channel information; and
wherein the information associated with the subband group comprises a total number of generated subband groups, subband group identification information to be used for identifying each subband group, and subband identification information to be used for identifying a subband included in each subband group.

2. The method as claimed in claim 1, wherein the subband group comprises one or more subbands included in a first CC and one or more subbands included in a second CC; and
the channel information corresponds to information indicating a status of a downlink (DL) channel of the subbands included in the subband group.

3. The method as claimed in claim 2, wherein at least one of the first CC and the second CC does not include the control channel.

4. The method as claimed in claim 1, wherein the control channel corresponds to a physical downlink control channel (PUCCH).

5. The method as claimed in claim 1, wherein the channel information includes at least one of channel quality indicator (COI) information, a precoding matrix indicator (PMI), a rank indicator (RI), information indicating a degree of noise of a channel, information associated with an error occurring in a channel, channel status information, and information associated with measured quality of a channel.

6. The method as claimed in claim 1, further comprising:
receiving subband group updating request information from the UE; and
transmitting, to the UE, subband group updating information including a list of updated subband groups,
wherein the subband group updating request information comprises a portion corresponding to a generation code or a cancellation code indicating that a subband group is newly generated or cancelled, a portion indicating a total number of newly generated subband groups or cancelled subband groups, and a portion indicating identification information (number) to be used for identifying each generated or cancelled subband group and a subband included in each subband group.

7. A method for a user equipment (UE) to transmit channel information in a wireless communication system that uses at least one component carrier (CC), the method comprising:
transmitting, to a base station (BS), channel information associated with one or more subbands included in the at least one CC;
receiving, from the BS, information associated with a subband group generated by grouping the one or more subbands included in the at least one CC;
transmitting, to the BS through a control channel, group-based channel information of each subband by using the channel information associated with the one or more subbands as the group-based channel information of each subband corresponding to the subband group,
wherein the subband group comprises at least one subband having the same channel information; and
wherein the information associated with the subband group comprises a total number of generated subband groups, subband group identification information to be used for identifying each subband group, and subband identification information used for identifying a subband included in each subband group.

8. The method as claimed in claim 7, wherein the subband group comprises one or more subbands included in a first CC and one or more subbands included in a second CC; and
the channel information corresponds to information indicating a status of a downlink (DL) channel of the subbands included in the subband group.

9. The method as claimed in claim 8, wherein at least one of the first CC and the second CC does not include the control channel.

10. The method as claimed in claim 7, wherein the control channel corresponds to a physical downlink control channel (PUCCH).

11. The method as claimed in claim 7, wherein the channel information comprises at least one of channel quality indicator (COI) information, a precoding matrix indicator (PMI), a rank indicator (RI), information indicating a degree of noise of a channel, information associated with an error occurring in a channel, channel status information, and information associated with measured quality of a channel.

12. The method as claimed in claim 7, further comprising:
extracting a parameter to be used for updating a subband group, based on subband-based channel information associated with each of the at least one CC and subband group-based channel information; and
generating subband group updating request information when the parameter exceeds a tolerance, and transmitting the subband group updating request information to the BS,
wherein the subband group updating request information comprises a portion corresponding to a generation code or a cancellation code indicating that a subband group is newly generated or cancelled, a portion indicating a total number of newly generated subband groups or cancelled subband groups, and a portion indicating identification information (number) to be used for identifying each generated or cancelled subband group and a subband included in each subband group.

13. A wireless communication system, the system comprising:
a subband grouping management unit to generate a subband group with respect to one or more subbands included in at least one component carrier (CC), based on channel information received from a user equipment (UE); and
a transceiving unit to transmit subband grouping information associated with the subband group to the UE, and to receive group-based channel information of each subband corresponding to the subband group through a control channel,
wherein the subband group comprises at least one subband having the same channel information; and
wherein the information associated with the subband group comprises a total number of generated subband groups, subband group identification information to be used for identifying each subband group, and subband identification information to be used for identifying a subband included in each subband group.

14. The system as claimed in claim 13, wherein the subband group comprises one or more subbands included in a first component carrier (CC) and one or more subbands included in a second CC; and
the channel information corresponds to information indicating a status of a downlink (DL) channel of the subbands included in the subband group.

15. The system as claimed in claim 14, wherein at least one of the first CC and the second CC does not include the control channel.

16. The system as claimed in claim 13, wherein the control channel corresponds to a physical downlink control channel (PUCCH).

17. The system as claimed in claim 13, wherein the channel information comprises at least one of channel quality indicator (COI) information, a precoding matrix indicator (PMI), a rank indicator (RI), information indicating a degree of noise of a channel, information associated with an error occurring in a channel, channel status information, and information associated with measured quality of a channel.

18. The system as claimed in claim 13, wherein, when the transceiving unit receives subband group updating request information from the UE, the subband grouping management unit generates subband group updating information including a list of updated subband groups,
wherein the subband group updating request information comprises a portion corresponding to a generation code or a cancellation code indicating that a subband group is newly generated or cancelled, a portion indicating a total number of newly generated subband groups or cancelled subband groups, and a portion indicating identification information (number) to be used for identifying each generated or cancelled subband group and a subband included in each subband group.

19. A user equipment (UE), the UE comprising:
a receiving unit to receive, from a base station (BS), subband grouping information associated with a subband group generated by grouping one or more subbands included in at least one component carrier (CC);
a subband channel information measuring unit to measure channel information associated with the one or more subbands included in the at least one CC;
a subband group channel information measuring unit to form, using the channel information associated with the one or more subbands, group-based channel information of each subband corresponding to the subband grouping information; and
a transmitting unit to transmit the group-based channel information of each subband corresponding to the subband group to the BS through a control channel.

20. The UE as claimed in claim 19, wherein the subband group comprises one or more subbands included in a first component carrier (CC) and one or more subbands included in a second CC; and
the channel information corresponds to information indicating a status of a downlink (DL) channel of the subbands included in the subband group.

21. The UE as claimed in claim 20, wherein at least one of the first CC and the second CC does not include the control channel.

22. The UE as claimed in claim 20, wherein the control channel corresponds to a physical downlink control channel (PUCCH).

23. The UE as claimed in claim 19, wherein the channel information includes at least one of channel quality indicator (C01) information, a precoding matrix indicator (PMI), a rank indicator (RI), information indicating a degree of noise of a channel, information associated with an error occurring in a channel, channel status information, and information associated with measured quality of a channel.

24. The UE as claimed in claim 19, further comprising:
an update parameter extracting unit to extract a parameter to be used for updating a subband group, based on the channel information measured by the subband channel information measuring unit and the subband group-based channel information measured by the subband group channel information measuring unit,
wherein the transmitting unit generates subband group updating request information when the parameter exceeds a tolerance, so as to transmit the subband group updating request information to the BS; and
wherein the subband group updating request information comprises a portion corresponding to a generation code or a cancellation code indicating that a subband group is newly generated or cancelled, a portion indicating a total number of newly generated subband groups or cancelled subband groups, and a portion indicating identification information (number) to be used for identifying each generated or cancelled subband group and a subband included in each subband group.
